(19) United States
(12) Patent Application Publication
(10) Pub. No.: US 2017/0168704 A1
(43) Pub. Date: Jun. 15, 2017

(54) APPARATUS AND METHOD FOR DESKTOP PRESENTATION LOGIC CONTROL OF A HANDHELD DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yuan TIAN, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/237,167

(22) Filed: Aug. 15, 2016

Related U.S. Application Data
(63) Continuation of application No. PCT/CN2016/089516, filed on Jul. 10, 2016.

(30) Foreign Application Priority Data
Dec. 15, 2015 (CN) 2015109339538

(51) Int. Cl. G06F 3/0488; G06F 3/042; G06F 3/0481; G06F 3/0483

(52) U.S. Cl. CPC G06F 3/04883; G06F 3/0483; G06F 3/0421; G06F 3/04886; G06F 3/04817; G06F 2203/04803

(57) ABSTRACT

Embodiments of the present disclosure relate to the field of technologies for controlling desktop presentation logic of a handheld device, and disclose an apparatus and method for controlling desktop presentation logic of a handheld device. The apparatus includes: a receiver, configured to receive a control instruction for changing desktop presentation logic and a launch instruction for starting one or more applications; and a controller, configured to modify a program launcher according to the control instruction and the start instruction, so as to present the one or more applications in a form of a desktop. According to the present disclosure, a program launcher is modified so as to present started applications in a form of a desktop, so that a user can conveniently switch between the started applications by sliding on the screen.

### CROSS-REFERENCE TO RELATED APPLICATIONS

This application is a continuation of International Application No. PCT/CN2016/089516, filed on 10 Jul. 2016, which claims priority to Chinese Patent Application No. 201510933953.8, filed on Dec. 15, 2015, both of which are hereby incorporated by reference in their entireties.

### TECHNICAL FIELD

This present disclosure relates to technologies for controlling desktop presentation logic of a handheld device, and specially, to an apparatus and method for controlling desktop presentation logic of a handheld device.

### BACKGROUND

With the rapid development of electronic products, handheld devices have become indispensable electronic products for people. Handheld devices have far more functions than their basic functions, people not only can make calls and send messages by using a handheld device (for example, a mobile phone), but also can browse web pages, play games, watch videos, start navigation and so on by using a handheld device, most of functions that could be achieved by a computer can be implemented by a handheld device in a more convenient way.

Such functions of a handheld device are mostly implemented by means of applications (APP), when a user starts an application, the application is presented to the user in a form of a page that covers a desktop presented on the handheld device. Therefore, when a user starts multiple applications at the same time, these applications are presented to the user via multiple pages that cover the desktop presented on the mobile phone respectively.

Currently, a user can switch only among multiple pages on a desktop by sliding on the screen, and cannot switch among multiple started applications by sliding on the screen, in a case where the user starts multiple applications, if the user intends to switch from one application to another application, the user needs to exit the current application, and then tap the icon of the another application to enter the another application. That is, the user cannot switch from one application to another application if the user does not exit the current application.

### SUMMARY

An objective of some embodiments of the present disclosure is to provide an apparatus and method for controlling desktop presentation logic of a handheld device, so as to resolve a problem of switching started applications by sliding on the screen.

To achieve the foregoing objective, an embodiment of the present disclosure provides an apparatus for controlling desktop presentation logic of a handheld device, and the apparatus includes: a receiver, configured to receive a control instruction for changing desktop presentation logic and a launch instruction for starting one or more applications; and a controller, configured to modify a program launcher according to the control instruction and the start instruction, so as to display the one or more applications in a form of a desktop.

Correspondingly, another embodiment of the present disclosure further provides a method for controlling desktop presentation logic of a handheld device, and the method includes: receiving a control instruction for changing desktop presentation logic and a launch instruction for starting one or more applications; and modifying a program launcher according to the control instruction and the start instruction, so as to display the one or more applications in a form of a desktop.

According to an embodiment of the present disclosure, there is provided with a non-transitory computer-readable storage medium storing executable instructions that, when executed by an electronic device with a touch-sensitive display, cause the electronic device to perform an above disclosed method.

By means of the foregoing technical solutions, according to some embodiments of the present disclosure, a program launcher is modified so as to present started applications in a form of a desktop, so that a user can conveniently switch between the started applications by sliding on the screen.

Other features and advantages of the present disclosure will be described in detail in the detailed embodiments below.

### BRIEF DESCRIPTION OF THE DRAWINGS

The accompanying drawings are used to provide a further understanding of the present disclosure, and constitute a part of the specification, which are used to explain the present disclosure in combination with the detailed embodiments below, and do not constitute a limitation to the present disclosure. In the accompanying drawings:

FIG. 1 is a block diagram of an apparatus for controlling desktop presentation logic of a handheld device according to an embodiment of the present disclosure;

FIG. 2 is a diagram illustrating the change in the arrangement sequence of a desktop display stack according to an embodiment of the present disclosure; and

FIG. 3 is a flowchart of a method for controlling desktop presentation logic of a handheld device according to an embodiment of the present disclosure.

FIG. 4 is a schematic hardware diagram of an electronic apparatus for performing a method of controlling desktop presentation logic according to an embodiment of the present disclosure.

### DETAILED DESCRIPTION

Specific implementation manners of some embodiments of the present disclosure are described in detail below with reference to the accompanying drawings. It should be understood that the specific implementation manners described herein are merely for the purpose of illustrating and explaining the present disclosure, but are not intended to limit the present disclosure.

A screen of a handheld device described in some embodiments of the present disclosure has a meaning in broad sense, in some embodiments of the present disclosure, the screen of the handheld device is divided into a display screen area and non-display screen area, the display screen area refers to a screen area for displaying content to be presented to a user, and the non-display screen area refers to an area in which touching is detected by using infrared or other methods.

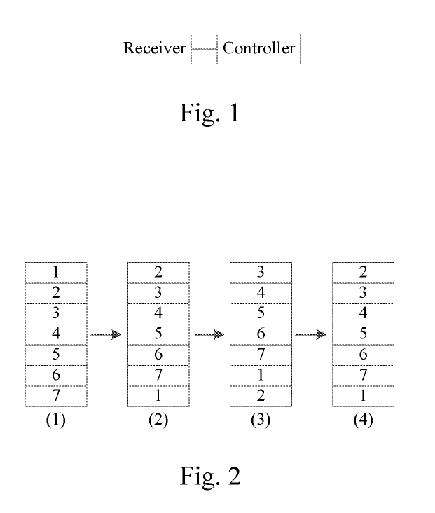

FIG. 1 is a block diagram of an apparatus for controlling desktop presentation logic of a handheld device according to an embodiment of the present disclosure, as shown in FIG. 1, the apparatus includes a receiver and a controller. The receiver is configured to receive a control instruction for changing desktop presentation logic and a launch instruction for starting one or more applications. The controller is configured to modify a program launcher according to the control instruction and the launch instruction that are received by the receiver, so as to present the one or more started applications in a form of a desktop.

A user may download multiple applications via a handheld device, and icons of these applications are displayed on the desktop of the handheld device, which is similar to that of a computer, however, the desktop of the computer has only one page, and icons of all applications in the computer are displayed on this page, the desktop of the handheld device has multiple pages, icons of applications in the handheld device may be distributed on the multiple pages, and the user can switch between the multiple pages of the desktop by sliding on a screen (which is generally a display screen area in the prior art) of the handheld device.

The foregoing control instruction for changing desktop presentation logic may be triggered by a particular key or tapping a particular icon, in a case where the receiver receives the control instruction, the user may select, from a list of applications in the handheld device, an application that the user intends to launch in the form of a desktop, when the user selects the application, the receiver receives a launch instruction for launching the application.

In the prior art, when a user launches an application, display of the application covers that of the desktop, rather than being part of the desktop, so that contents to be displayed by the application can be presented to the user. That the controller presents the one or more applications in a form of a desktop includes: adding presentation logic of the one or more applications to a desktop display stack, so as to present the one or more applications in a form of a desktop, where the desktop display stack further stores presentation logic of an original desktop.

The original desktop herein refers to a desktop on which icons of applications are displayed, that is, a conventional desktop, and the desktop display stack stores the presentation logic of the desktop. According to the technical solution provided by the present disclosure, an application started by a user can be presented in a form of a desktop, where presentation logic of started applications is added to a desktop display stack; before the user launches an application that needs to be presented via a desktop, presentation logic of the original desktop is stored in the desktop display stack; after the user launches the application that needs to be presented via a desktop, the presentation logic of the application is also stored in the desktop display stack.

The receiver shown in FIG. 1 is further configured to receive a sliding instruction, the sliding instruction indicates a sliding gesture on the screen of the handheld device, and the controller changes an arrangement sequence of the presentation logic of the one or more applications or the original desktop in the desktop display stack according to the sliding instruction, where in a case where the sliding instruction indicates that the sliding gesture is sliding leftward or sliding rightward, desktop presentation of the handheld device is switched from a current page to a page on the right or a page on the left.

The current page of the desktop of the handheld device that is presented to the user is a page that is on the topmost in the desktop display stack, when the user flicks on the screen of the handheld device, an arrangement sequence of the desktop presentation logic in the desktop display stack is changed. For example, when the receiver receives a sliding instruction indicating that a sliding gesture is sliding leftward, the page that is on the topmost in the desktop display stack is changed from the current page to the page that is on the right of the current page, and the desktop presentation of the handheld device is switched from the current page to the page that is on the right of the current page.

FIG. 2 is a diagram illustrating the change in the arrangement sequence of a desktop display stack according to an embodiment of the present disclosure. Assuming that a desktop of a handheld device currently has seven pages, the seven pages include a page of an original desktop and pages of applications that are presented in a form of a desktop. For ease of description, the seven pages are numbered, respectively page 1, page 2, page 3, page 4, page 5, page 6, and page 7. The page 2 is on the right of the page 1, the page 3 is on the right of the page 2, and the rest can be deduced by analogy. Certainly, the page 7 is on the right of the page 1. As shown in (1) of FIG. 2, the currently presented page is the page 1. Because the page 1 is currently on the topmost in the desktop display stack, in a case where the receiver receives a sliding instruction indicating that a sliding gesture is sliding leftward (which is only an assumption, and the sliding gesture may alternatively be sliding rightward), referring to (2) of FIG. 2, the controller places the page 1 at the bottom of the stack, and all the other pages rise by one layer. In this case, the page 2 is presented on the desktop of the handheld device. In a case where the receiver receives a sliding instruction indicating that a sliding gesture is sliding leftward again, referring to (3) of FIG. 2, the controller places the page 2 at the bottom of the stack, and all the other pages rise by one layer. In this case, the page 3 is presented on the desktop of the handheld device. Next, in a case where the receiver receives a sliding instruction indicating that a sliding gesture is sliding rightward, referring to (4) of FIG. 2, the controller places the page 2 on the topmost, and all the other pages fall by one layer. In this case, the page 2 is presented on the desktop of the handheld device.

In some applications, sliding on the screen is set as a manner of making a user to conveniently check content under different tags, therefore, to implement the technical solution provided by the present disclosure, for such applications, it needs to be preset that the switching a page of the desktop of the handheld device can be triggered only by a sliding gesture at a position where the sliding gesture causes no operation on the application. To meet general requirements, the sliding instruction may be obtained by means of a non-display screen area of the handheld device. For example, in a case where touching of the non-display screen area is determined by using infrared, for example, there are three infrared sensing touch keys on a same straight line, it may be determined whether the sliding instruction is sliding leftward or sliding rightward according to an order in which the three infrared sensing touch keys are touched.

The handheld device described in this embodiment includes a mobile phone, a tablet computer or the like.

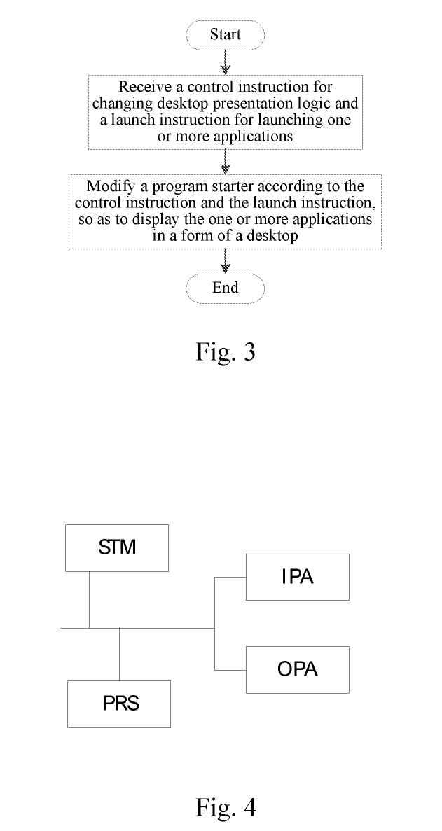

FIG. 3 is a flowchart of a method for controlling desktop presentation logic of a handheld device according to an embodiment of the present disclosure, as shown in FIG. 3, the method includes: receiving a control instruction for changing desktop presentation logic and a launch instruction for starting one or more applications; and modifying a program launcher according to the control instruction and the launch instruction, so as to display the one or more applications in a form of a desktop.

It should be noted that specific details and benefits of the method for controlling desktop presentation logic of a handheld device provided in this embodiment are similar to those of the apparatus for controlling desktop presentation logic of a handheld device provided by the present disclosure, and the details are not described herein again.

Although preferable implementation manners of some embodiments of the present disclosure have been described in detail above with reference to the accompanying drawings, the present disclosure is not limited to specific details in the foregoing implementation manners. Various simple variations can be made to the technical solutions of the present disclosure within the scope of the technical idea of the present disclosure, and such simple variations all fall within the protection scope of the present disclosure.

According to an embodiment of the present disclosure, there is provided with a non-transitory computer-readable storage medium storing executable instructions that, when executed by an electronic apparatus, cause the electronic apparatus to perform an above disclosed method.

FIG. 4 illustrates a schematic hardware diagram of an electronic apparatus for performing a method of controlling desktop presentation logic. According to FIG. 4, the electronic apparatus includes one or more processors PRS and a storage medium STM. FIG. 4 shows one processor PRS as an example.

The electronic apparatus can further include an input apparatus IPA and an output apparatus OPA.

The one or more processors PRS, storage medium STM and output apparatus OPA may be connected by a bus or other means. FIG. 4 shows a bus as an example for connection.

Storage medium STM is a non-transitory computer-readable medium for storing a non-transitory software program, a non-transitory computer-readable program and module, for example the program instructions/module for controlling desktop presentation logic of a handheld device (such as, controller shown in FIG. 1). The processor PRS can operate the various functions and data processing of a server to perform the method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but not limited to Internet, enterprise intranet, local area network, mobile telecommunication network and a combination thereof

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods. The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player(e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which units that are described above as separate elements may be physically separate or not separate and units that are described above as display elements may be or may not be a physical unit, i.e.in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

The previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

It should be further noted that the specific technical features described in the foregoing specific implementation manners can be combined in any appropriate manner as long as no conflict occurs. To avoid unnecessary repetition, various possible combination manners will not be described in the present disclosure.

In addition, various different implementation manners of the present disclosure may also be combined arbitrarily. Such combinations shall also be considered as the content disclosed by the present disclosure as long as these combinations do not depart from the concept of the present disclosure.

What is claimed is:

1. An apparatus for controlling desktop presentation logic of a handheld device, comprising:
a receiver, configured to receive a control instruction for changing desktop presentation logic and a launch instruction for launching one or more applications; and
a controller, configured to modify a program launcher according to the control instruction and the launch instruction, so as to display the one or more applications in a form of a desktop.

2. The apparatus according to claim 1, wherein to display the one or more applications in the form of the desktop, the controller is further configured to:
add presentation logic of the one or more applications to a desktop display stack, so as to display the one or more applications in the form of the desktop according to the desktop display stack;
wherein the desktop display stack further stores presentation logic of an original desktop.

3. The apparatus according to claim 2, wherein the receiver is further configured to receive a sliding instruction, wherein the sliding instruction indicates a sliding gesture on a screen of the handheld device; and
the controller is further configured to change a sequence of the presentation logic of the one or more applications or the presentation logic of the original desktop in the desktop display stack according to the sliding instruction, wherein
when the sliding instruction indicates that the sliding gesture is sliding leftward or sliding rightward, desktop presentation of the handheld device is switched from a current page to a page on the right or a page on the left respectively.

4. The apparatus according to claim 3, wherein the sliding instruction is obtained by means of a non-display screen area of the handheld device.

5. The apparatus according to claim 3, wherein the sliding instruction is determined sliding leftward or sliding rightward by an instruction which one or more infrared sensing touch keys have been touched at the same time or in a preset sequence.

6. The apparatus according to claim 1, wherein the handheld device comprises a mobile phone or a tablet computer.

7. The apparatus according to claim 1, wherein the desktop has multiple pages, the controller is further configured to distribute icons of the applications in the handheld device on the multiple pages.

8. The apparatus according to claim 1, wherein the control instruction for changing desktop presentation logic is triggered by a particular key or tapping a particular icon.

9. The apparatus according to claim 1, wherein a screen of the handheld device is divided into a display screen area and non-display screen area, the display screen area refers to a screen area for displaying content to be presented to a user, and the non-display screen area refers to an area in which touching is detected by using infrared.

10. A method for controlling desktop presentation logic of a handheld device, comprising:
receiving a control instruction for changing desktop presentation logic and a launch instruction for launching one or more applications; and
modifying a program launcher according to the control instruction and the launch instruction, so as to display the one or more applications in a form of a desktop.

11. The method according to claim 10, wherein to display the one or more applications in the form of the desktop the method further comprises:
adding presentation logic of the one or more applications to a desktop display stack, so as to display the one or more applications in the form of the desktop according to the desktop display stack;
wherein the desktop display stack further stores presentation logic of an original desktop.

12. The method according to claim 11, wherein the method further comprises:
receiving a sliding instruction, wherein the sliding instruction indicates a sliding gesture on a screen of the handheld device; and
changing a sequence of the presentation logic of the one or more applications or the presentation logic of the original desktop in the desktop display stack according to the sliding instruction,
wherein when the sliding instruction indicates that the sliding gesture is sliding leftward or sliding rightward, desktop presentation of the handheld device is switched from a current page to a page on the right or a page on the left respectively.

13. The method according to claim 12, wherein the sliding instruction is obtained by means of a non-display screen area of the handheld device.

14. The method according to claim 13, further comprising:
determining whether the sliding instruction is sliding leftward or sliding rightward according to an order in which the three infrared sensing touch keys are touched.

15. The method according to claim 10, wherein the handheld device comprises a mobile phone or a tablet computer.

16. The method according to claim 10, wherein the desktop has multiple pages, the method further comprises:
distributing icons of the applications in the handheld device on the multiple pages.

17. The method according to claim 10, wherein the method further comprises:
triggering the control instruction for changing desktop presentation logic by a particular key or tapping a particular icon.

18. The method according to claim 10, wherein a screen of the handheld device is divided into a display screen area and non-display screen area, the display screen area refers to a screen area for displaying content to be presented to a user, and the non-display screen area refers to an area in which touching is detected by using infrared.

19. A non-transitory computer-readable storage medium storing executable instructions that, when executed by an electronic apparatus, cause the electronic apparatus to:
receive a control instruction for changing desktop presentation logic and a launch instruction for starting one or more applications; and,
modify a program launcher according to the control instruction and the launch instruction, so as to display the one or more applications in a form of a desktop.

20. The storage medium according to claim 19, wherein storage medium further comprises instructions to add presentation logic of the one or more applications to a desktop display stack, so as to display the one or more applications in the form of the desktop;
wherein the desktop display stack further stores presentation logic of an original desktop.
